(19) United States
(12) Patent Application Publication
(10) Pub. No.: US 2006/0031322 A1
(43) Pub. Date: Feb. 9, 2006

(54) Associating an instant message dialog with screen real estate and role based positioning

(75) Inventors: Bethany Lyn Kessen, Austin, TX (US); Craig M. Lawton, Raleigh, NC (US); Jonathan Andrew Lewis, Morrisville, NC (US); Martin Thomas Moore, Somerville, MA (US); Jesse B. Overby III, Raleigh, NC (US); Christopher Andrew Peters, Pflugerville, TX (US); Lorin Evan Ullmann, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/875,945

(22) Filed: Jun. 24, 2004

(51) Int. Cl. G06F 15/16; G06F 3/00

(52) U.S. Cl. 709/206; 715/781

(57) ABSTRACT

A method, apparatus, and computer instructions for allowing areas of a display to be associated with particular instant messaging users. The present invention provides a menu option to allow a user to select whether to have instant messaging dialog windows open up in the same position as the current window, or alternatively, to have the dialog windows from a specific person open up in a specified location on the display. Thus, the instant messaging software may allow window positions to be associated and “saved” with particular users. A user may create roles or add individual people to a preferences list to allow for different instant messaging window preferences for each role or person. In this manner, a user may specify areas of the display in which an instant messaging dialog window may open according to the various roles.

### BACKGROUND OF THE INVENTION

1. Technical Field

The present invention relates generally to an improved data processing system for processing and displaying messages. Still more particularly, the present invention provides a method, apparatus, and computer instructions for positioning dialog windows in instant messaging systems.

2. Description of Related Art

Instant messaging is an online chat medium, allowing users to communicate with each other and to collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available. Millions of users communicate using instant messaging systems every day. With instant messaging becoming an important part of both personal and business communications, functionality and usability enhancements are important to the continued success of this type of communication tool.

When an instant messaging conversation is started, dialog windows are created and positioned in the windowing system. The position in which a new dialog window appears is typically determined by either the instant messaging application or by the operating system. A user may locate the dialog window on the screen and carry on a conversation with a user through the dialog window. However, if the user is engaged in several conversations at once, it may be confusing and cumbersome for the user to locate the dialog window that is associated with a particular user. Presently available instant messaging systems allow a user to save the position of a dialog window on the screen. However, the positioning ability provided by these existing messaging systems is solely based on the existing dialog window. There is no ability in current messaging systems for associating and saving a dialog window position on a screen with a particular user.

Therefore, it would be advantageous to have a method, apparatus, and computer instructions for allowing screen positions of instant messaging dialog windows to be associated and saved with particular instant messaging users.

### SUMMARY OF THE INVENTION

The present invention provides a method, apparatus, and computer instructions for allowing areas of a display to be associated with particular instant messaging users. The present invention provides a menu option to allow a user to select whether to have instant messaging dialog windows open up in the same position as the current window, or alternatively, to have the dialog windows from a specific person open up in a specified location on the display. Thus, the instant messaging software may allow window positions to be associated and “saved” with particular users. A user may create roles or add individual people to a preferences list to allow for different instant messaging window preferences for each role or person. In this manner, a user may specify areas of the display in which an instant messaging dialog window may open according to the various roles.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating components used in managing messages in accordance with a preferred embodiment of the present invention;

FIG. 5 is a diagram illustrating an instant messaging client in accordance with a preferred embodiment of the present invention;

FIG. 6 is an example display illustrating how current instant messaging applications place instant messaging dialog windows for a particular user;

FIG. 7 is an example display illustrating how dialog windows may be opened in specified areas of the desktop for various roles in accordance with the present invention;

FIG. 8 is an example display illustrating how a user may associate a particular user or role with a specific location on the desktop in accordance with a preferred embodiment of the present invention;

FIG. 9 is an example preferences window for managing where instant messaging dialog windows are displayed in accordance with a preferred embodiment of the present invention; and

FIG. 10 is a flowchart of a process for displaying an instant message window on the desktop in accordance with a preferred embodiment of the present invention.

### DETAILED DESCRIPTION OF THE PREFERRED EMBODIMENT

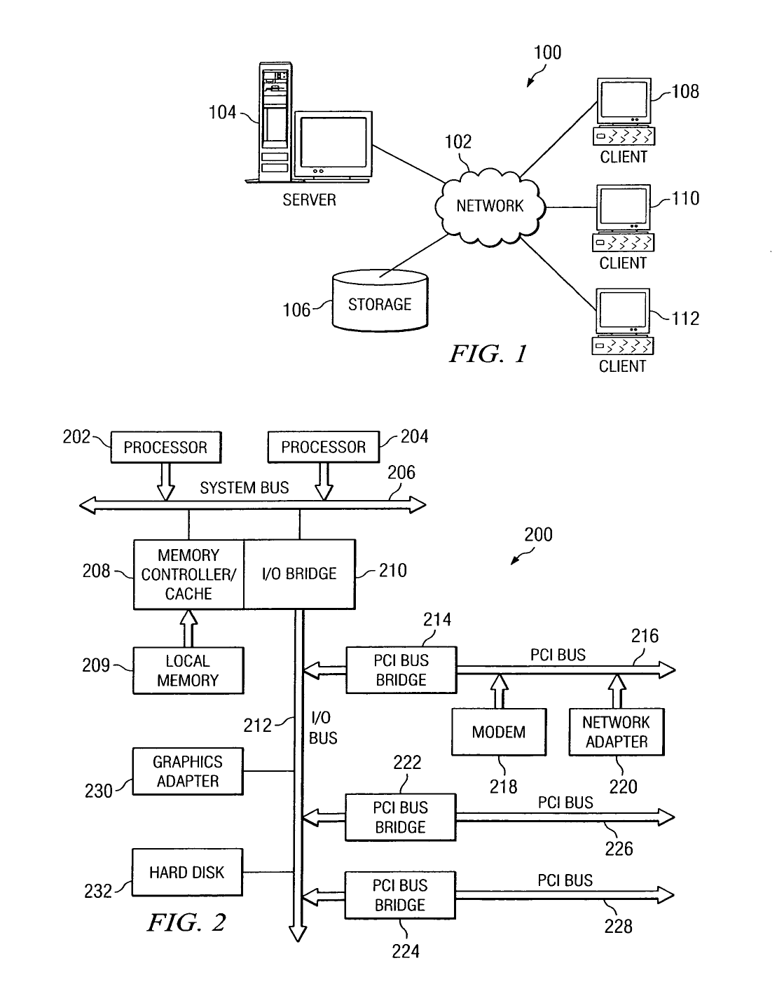

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers or personal digital assistants (PDAs). In the depicted example, server 104 provides data, such as boot files, operating system images, and applications to clients 108-112. Clients 108, 110, and 112 are clients to server 104. Server 104 may act as an instant messaging server to facilitate the exchange of messages between users at clients, such as clients 108, 110, and 112. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

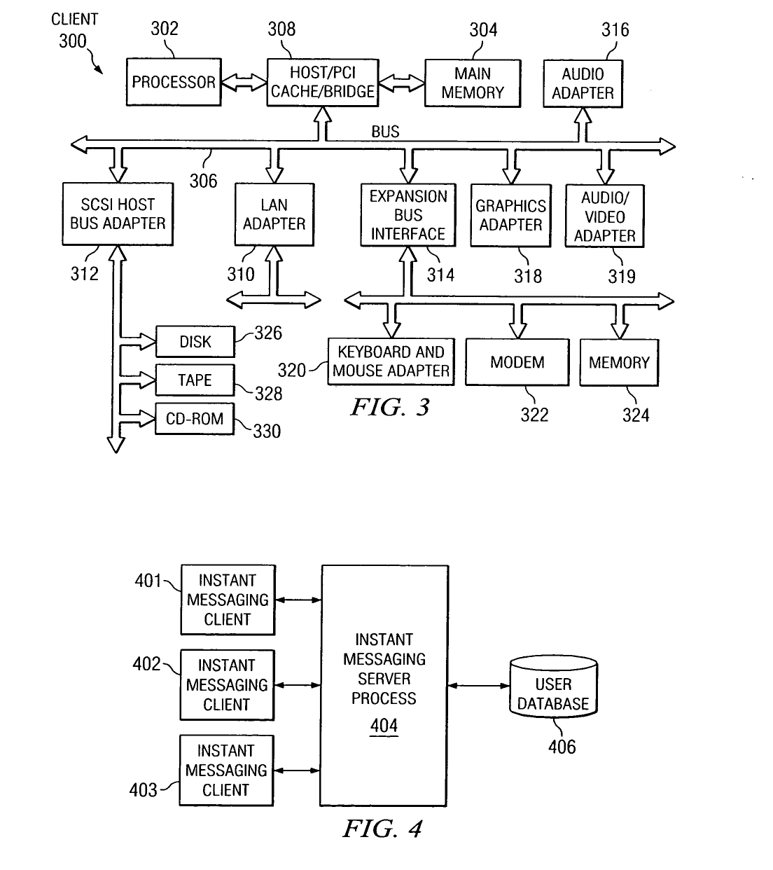

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for allowing areas or locations of a display or computer screen to be associated with particular instant messaging users. The present invention overcomes problems associated with current instant messaging systems by saving a window position for an instant messaging dialog window for a particular user so as to allow a user to easily locate a particular messaging window on the display. In addition, the user may know who sent a message if a message box appeared in a particular location on the display.

The mechanism of the present invention provides a menu option to allow a user to select whether to have the instant messaging dialog window from a specific person or role open up in a specified location on the screen. Thus, the instant messaging software may allow window positions to be associated and “saved” with particular users. A user may create roles or add individual people to a preferences list to allow for different instant messaging dialog window preferences for each role or person. In this manner, a user may specify areas of the display on which dialog windows may open according to the various roles. In addition, in an illustrative embodiment, a menu option may be provided by the instant messaging application to allow a user to select whether to have all instant messaging dialog windows open up in the same position.

Turning now to FIG. 4, a block diagram illustrating components used in an instant messaging system in accordance with a preferred embodiment of the present invention is shown. In this illustrative example, a user at instant messaging client 401 may send or exchange messages with other users at instant messaging clients 402 and 403. These instant messaging clients may be executing on a data processing system, such as data processing system 300 in FIG. 3. The exchange of messages in these examples is facilitated through instant messaging server process 404. This process allows for users to find other users within the instant messaging system as well as aid in the exchange of messages between different users.

Depending on the particular instant messaging system, instant messaging server process 404 may only be involved in providing an indication of when particular users are online and for establishing initial contacts while users contacting users already on a buddy list may contact those users directly after seeing that a particular user is online. Instant messaging server process 404 may be located on a server, such as data processing system 200 in FIG. 2.

In these examples, the different users registered to the instant messaging system are stored in user database 406. This user database provides information needed to search for and find other users as well as contact users when they are online.

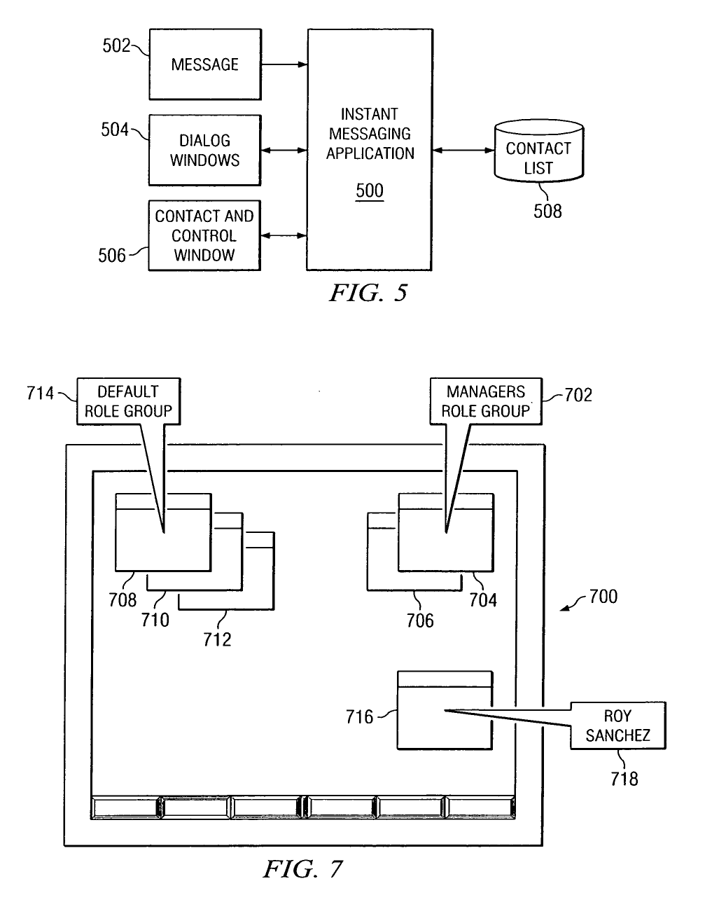

Turning next to FIG. 5, a diagram illustrating an instant messaging client is depicted in accordance with a preferred embodiment of the present invention. The components illustrated in FIG. 5 may be found in an instant messaging client, such as instant messaging client 401, 402, or 403 in FIG. 4. These components may be implemented in a data processing system, such as data processing system 300 in FIG. 3.

In the illustrative example, instant messaging application 500 processes messages, such as message 502, received from users located on remote data processing systems. As messages are received, these messages are presented in dialog windows 504. Additionally, dialog windows 504 provide an interface for a user to input text to send messages to other users.

Contact and control window 506 is presented by instant messaging application 500 to provide the user with a list of user names, as well as other information. Contact and control window 506 also provides an interface to allow a user to set different preferences. For example, the user may set passwords required to access different names used in instant messaging sessions.

Also, a user may employ contact and control window 506 to set other preferences, such as colors and fonts used in instant messaging application 500. These preferences also may include whether a picture is to be sent when a session is initiated with another user. Depending on the implementation, the preference may be set to allow a user who receives messages to retrieve images of the senders from a remote database or a local cache.

Further, a list of names presented by contact and control window 506 are stored in contact list 508 in these examples. Additional user or screen names may be added to or deleted from contact list 508. This contact list is employed in presenting the list of names within contact and control window 506.

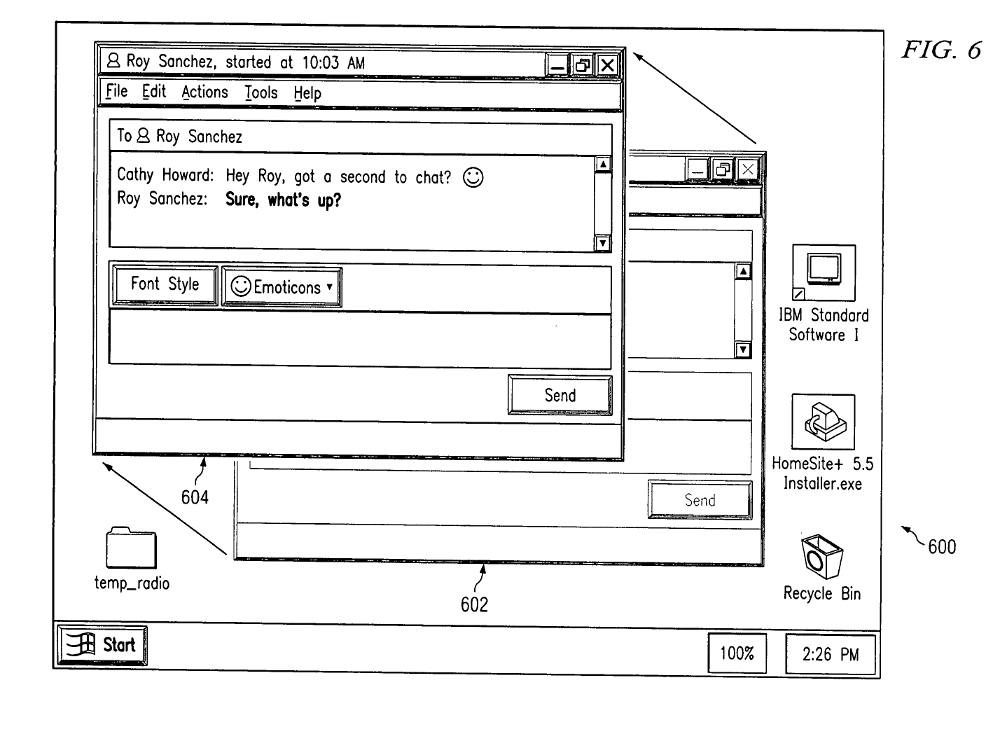

With reference now to FIG. 6, a diagram illustrating how current instant messaging applications place instant message dialog windows for a particular user is depicted. In current instant messaging systems, when an instant messaging conversation is started, dialog windows are created and positioned on a screen or display by the windowing system at random. For example, desktop 600 shows a conversation being conducted between two parties, Cathy Howard and Roy Sanchez. User Roy Sanchez receives instant messaging dialog window 602 on his desktop when user Cathy Howard initiates a conversation. Instant messaging dialog window 602 arrives on desktop 600 in a random position. The position in which a new dialog window appears is typically determined by either the instant messaging application or by the operating system.

As can be seen, the user may reposition instant messaging dialog window 602 containing the conversation with Cathy Howard to a new position on desktop 600. For instance, FIG. 6 shows instant messaging dialog window 602 moved from the original position on desktop 600 to new position 604 on the desktop. The user may subsequently locate instant messaging dialog window 602 on the desktop 600 and carry on a conversation with a user through the dialog window. However, if a new dialog window is created between the same parties, the user must again move the dialog window to a desired screen position. If the user is engaged in several conversations at once (several instant messaging dialog windows opened on desktop 600), it may be confusing and cumbersome for the user to locate instant messaging dialog window 602 that is associated with a particular user.

Turning next to FIG. 7, an example display illustrating how dialog windows may be opened in specified areas of the desktop for various roles is depicted in accordance with the present invention. In this example, desktop 700 contains various instant messaging dialog windows, such as dialog windows 702-712. Dialog windows 702-712 are examples of dialog window 504 in FIG. 5. Dialog windows 702-712 are presented for purposes of illustration and not meant as a limitation as to how messages may be presented. A dialog window may be displayed on desktop 700 when a message is received from another party or when the user initiates a conversation with another party.

In the particular example shown in FIG. 7, desktop 700 has been divided into three separate conversation areas according to the roles or individuals selected by the user. When a user starts a conversation, a dialog window is opened on desktop 700. The present invention allows a user to specify the location at which a dialog window associated with a particular user will open on the desktop. This feature allows the user to easily locate the dialog window, as well as allows the user to immediately identify the party who sent the new dialog window as it opens in a designated location on the desktop.

For example, the user may specify that one area of desktop 700, such as the upper right hand corner area, is designated for conversations with users within managers role group 702. Thus, all dialog windows that appear on desktop 700 containing conversations with the managers role group will be placed in the upper right hand corner of desktop 700, as shown by dialog windows 704 and 706.

Similarly, dialog windows 708, 710, and 712 may be opened in another designated area, such as the upper left hand corner of desktop 700. These dialog windows may contain conversations with another individual or role group, such as default role group 714. Dialog window 716 may likewise be opened in a different area of desktop 700. Dialog window 716 may contain a conversation with an individual, such as Roy Sanchez 718. In this manner, each particular area of desktop 700 is associated with a particular user or role, such that a new dialog window associated with a particular user or role will be opened in the designated area of desktop 700.

Although the example in FIG. 7 illustrates displaying the dialog windows in different corners of desktop 700, it should be noted that any manner of presenting the associated dialog windows may be used. As the user receives a dialog window from a particular user, the new dialog window is automatically placed in the designated area of desktop 700 as specified by the association of the particular user.

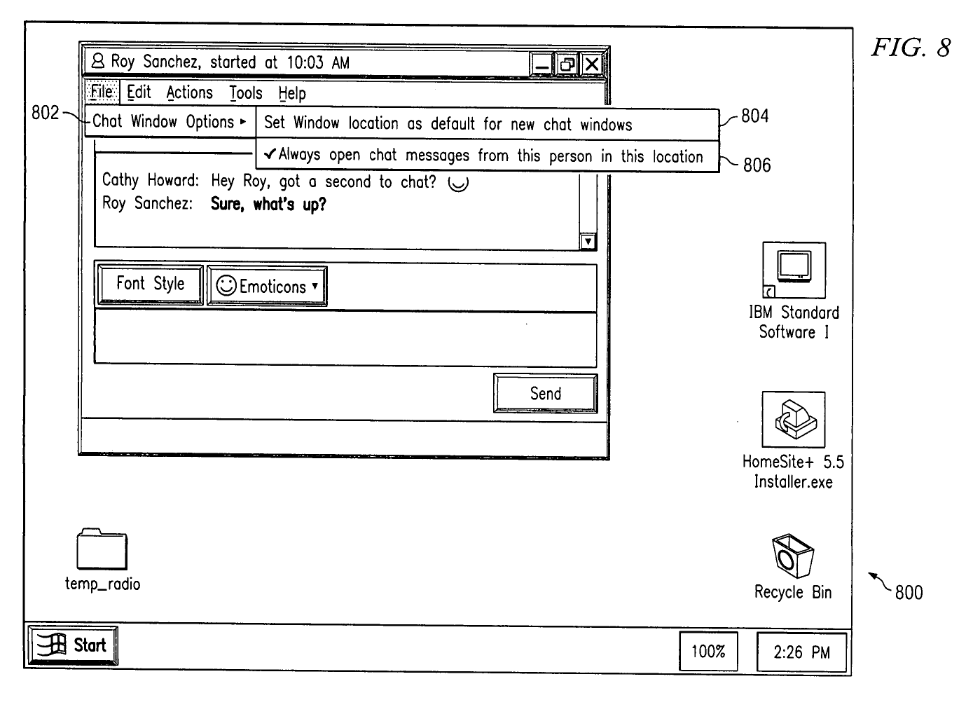

Turning now to FIG. 8, an example display illustrating how a user may associate a particular user or role with a specific location on the desktop in accordance with a preferred embodiment of the present invention is shown. Dialog window 800 is an example of dialog window 504 in FIG. 5. Dialog window 800 is presented for purposes of illustration and not meant as a limitation as to how messages may be presented. Dialog window 800 is displayed when a message is received from another party or when the user initiates a conversation with another party.

In this example, dialog window 800 contains a conversation between a user and another party. According to the present invention, a menu option in dialog window 800, such as chat window options 802, is included to allow for the association of a particular user and the position where a dialog window containing a conversation with the user will be opened on the desktop.

When a conversation with the user and a particular party has been initiated, the user may associate the party with an area of the desktop by selecting a menu option, such as chat window options 802. By selecting the chat window options, the user is prompted to set the position of future dialog windows with this particular user. In this particular example, chat window options 802 allows the user to choose to have all new chat windows open up in the same position as the current window by selecting the option, “Set Window location as default for new chat window” 804. Thus, when another dialog window is opened on the user's desktop, this subsequent dialog window will open in the same position as the current window.

Alternatively, chat window options 802 allows the user to choose to have only dialog windows from a particular user open up in the same position as the current window by selecting the option, “Always open chat messages from this person in this location” 806. In response, the current position of dialog window 800 is associated with the particular user. Thus, when another dialog window from that particular user is opened on the user's desktop, this new dialog window is opened in the same position as the previous dialog window based on the selected display preferences.

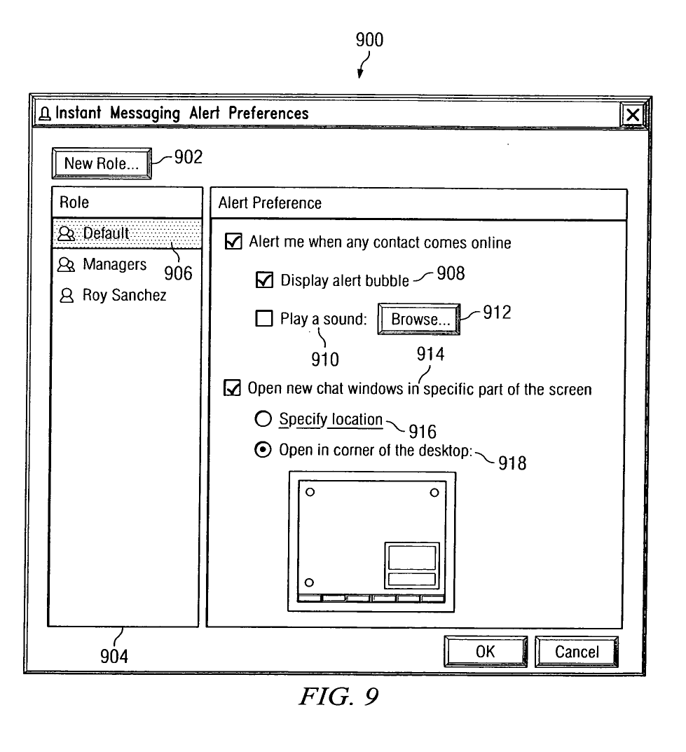

FIG. 9 is an example preferences dialog box for managing where instant messaging dialog windows are displayed in accordance with a preferred embodiment of the present invention. Preferences dialog box 900 may be presented to the user in a window, such as contact and control window 506 in FIG. 5. Preferences dialog box 900 provides a user with the ability to create roles or add individual people to a list. Preferences for instant messaging dialog windows may then be assigned to each role or individual in the list.

In this particular example, preferences dialog box 900 contains new role button 902. New role button 902 may be used to add a new role or individual to role list 904. When a particular role or user is selected in role list 904, the display preferences for that role or individual may be set by the user. For example, default role 906 is selected in role list 904. The user may choose preference options for the role, such as alerting the user when any person in default role 906 comes online via displaying an alert bubble 908 or by playing a sound 910. The user may further define which sound will be played by selecting browse button 912. The user may also select display preference 914 which allows the user to choose to open the dialog window in a specific part of the screen. For example, the user may select to open the dialog window in a specific location 916 or a particular corner of the desktop 918. Although the example in FIG. 9 shows particular preference options, one of ordinary skill in the art would recognize that other preferences may be used in preferences dialog box 900 to alert the user to incoming instant messages, as well as provide the user with the capability to manage the display of the instant messages.

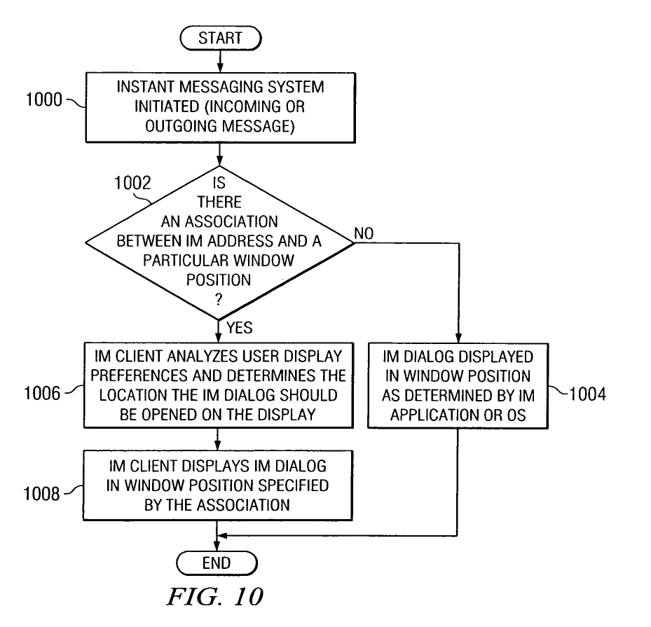

Turning next to FIG. 10, a flowchart of a process for displaying an instant message window on the display in accordance with a preferred embodiment of the present invention. The process illustrated in FIG. 10 may be implemented in an instant messaging application, such as instant messaging application 500 in FIG. 5.

The process begins by initiating an instant message dialog window in response to an incoming or outgoing message (step 1000). The client analyzes the new instant message to determine whether an association between the instant message address and a particular window position exists (step 1002). If there is no association, the instant message is displayed in a random position according to the settings in the instant messaging application or operating system (step 1004).

If an association exists, the client analyzes display preferences selected by the user and determines the location that the instant message should be opened on the display (step 1006). This determination may be made by matching the instant message to an entry in a list of identified roles or individuals, and identifying the user preferences for the particular role of individual. For example, when a new instant messaging window is created (by either receiving or sending a message) the ID of the instant messaging partner may be checked against a “window policy”. If the user has an individual “location policy” (for instance, “Roy Sanchez” in FIG. 9) then the instant messaging dialog will be opened in the location specified by the individual policy. If the instant messaging partner ID does not have an individual policy, the roles may be checked (for instance, the “managers” role in FIG. 9) and the instant messaging dialog will be opened in the location on the display specified by the role policy. If the instant messaging partner ID is not a member of a specific role, then a “default” location policy may be used. Once the window position has been determined, the instant message dialog is displayed in the position specified by the association (step 1008), with the process terminating thereafter.

Thus, the present invention provides a method, apparatus, and computer instructions for associating an instant message dialog for particular users in an instant messaging system with screen real estate. In these examples, the mechanism of the present invention provides a menu option to allow a user to select whether to have the instant message dialogs from a specific person or role open up in a specified location on the display. In this manner, an advantage is provided over current instant messaging systems by saving a window position for an instant message dialog for a particular user so as to allow a user to easily locate a particular message dialog on the display. In addition, the user may know who sent a message if a message box appeared in a particular location on the display. Thus, the instant messaging software may allow window positions to be associated and “saved” with particular users.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in an instant messaging client for associating an instant messaging dialog with screen real estate, comprising:
responsive to an input to create an instant messaging dialog on a display, determining whether an association between an instant messaging address in the instant messaging dialog and a position on the display exists; and
responsive to a determination that an association exists, displaying the instant messaging dialog in the position specified by the association.

2. The method of claim 1, wherein the instant messaging dialog is created in response to an incoming message.

3. The method of claim 1, wherein the instant messaging dialog is created in response to an outgoing message.

4. The method of claim 2, wherein displaying the instant messaging dialog in the position specified by the association allows a user to immediately identify the party who sent the incoming message.

5. The method of claim 1, where associations between instant messaging users and instant messaging dialog positions are defined by the instant messaging client.

6. The method of claim 1, wherein an instant messaging dialog position is associated with an individual.

7. The method of claim 1, wherein an instant messaging dialog position is associated with a role.

8. The method of claim 1, wherein the determination includes analyzing a user's ID against a window policy to determine if an instant messaging user is associated with an individual location policy.

9. The method of claim 8, in response to determining that the instant messaging user is not associated with an individual location policy, determining if the instant messaging user is a member of a particular role.

10. The method of claim 9, in response to determining that the instant messaging user is not associated with an individual location policy and is not a member of a particular role, applying a default location policy for the instant messaging dialog with the instant messaging user.

11. A data processing system for associating an instant messaging dialog with screen real estate, comprising:
responsive to an input to create an instant messaging dialog on a display, determining means for determining whether an association between an instant messaging address in the instant messaging dialog and a position on the display exists; and
displaying means for displaying the instant messaging dialog in the position specified by the association in response to a determination that an association exists.

12. The data processing system of claim 11, wherein the instant messaging dialog is created in response to an incoming message.

13. The data processing system of claim 11, wherein the instant messaging dialog is created in response to an outgoing message.

14. The data processing system of claim 13, wherein displaying the instant messaging dialog in the position specified by the association allows a user to immediately identify the party who sent the incoming message.

15. The data processing system of claim 11, where associations between instant messaging users and instant messaging dialog positions are defined by the instant messaging client.

16. The data processing system of claim 11, wherein an instant messaging dialog position is associated with an individual.

17. The data processing system of claim 11, wherein an instant messaging dialog position is associated with a role.

18. The data processing system of claim 11, wherein the determination includes analyzing a user's ID against a window policy to determine if an instant messaging user is associated with an individual location policy.

19. The data processing system of claim 18, in response to determining that the instant messaging user is not associated with an individual location policy, determining if the instant messaging user is a member of a particular role.

20. The data processing system of claim 19, in response to determining that the instant messaging user is not associated with an individual location policy and is not a member of a particular role, applying a default location policy for the instant messaging dialog with the instant messaging user.

21. A computer program product in a computer readable medium for associating an instant messaging dialog with screen real estate, comprising:
responsive to an input to create an instant messaging dialog on a display, first instructions for determining whether an association between an instant messaging address in the instant messaging dialog and a position on the display exists; and
second instructions for displaying the instant messaging dialog in the position specified by the association in response to a determination that an association exists.

22. The computer program product of claim 21, wherein the instant messaging dialog is created in response to an incoming message.

23. The computer program product of claim 21, wherein the instant messaging dialog is created in response to an outgoing message.

24. The computer program product of claim 23, wherein displaying the instant messaging dialog in the position specified by the association allows a user to immediately identify the party who sent the incoming message.

25. The computer program product of claim 21, where associations between instant messaging users and instant messaging dialog positions are defined by the instant messaging client.

26. The computer program product of claim 21, wherein an instant messaging dialog position is associated with an individual.

27. The computer program product of claim 21, wherein an instant messaging dialog position is associated with a role.

28. The computer program product of claim 21, wherein the determination includes analyzing a user's ID against a window policy to determine if an instant messaging user is associated with an individual location policy.

29. The computer program product of claim 28, in response to determining that the instant messaging user is not associated with an individual location policy, determining if the instant messaging user is a member of a particular role.

30. The computer program product of claim 29, in response to determining that the instant messaging user is not associated with an individual location policy and is not a member of a particular role, applying a default location policy for the instant messaging dialog with the instant messaging user.
